(19) United States
(12) Patent Application Publication
(10) Pub. No.: US 2009/0205899 A1
(43) Pub. Date: Aug. 20, 2009

(54) Acoustic Imaging Away From the Borehole Using a Low-Frequency Quadrupole Excitation

(75) Inventors: Tim W. Geerits, Nienhagen (DE); Xiao Ming Tang, Sugar Land, TX (US); Yibing Zheng, Houston, TX (US); Douglas J. Patterson, Spring, TX (US); Holger Mathiszik, Eicklingen (DE)

Correspondence Address: MADAN & SRIRAM, P.C., 2603 AUGUSTA DRIVE, SUITE 700, HOUSTON, TX, 77057-5662, US

(73) Assignee: Baker Hughes Incorporated, Houston, TX (US)

(21) Appl. No.: 12/388,227

(22) Filed: Feb. 18, 2009

Related U.S. Application Data
(60) Provisional application No. 61/029,806, filed on Feb. 19, 2008.

(51) Int. Cl. G01V 1/40

(52) U.S. Cl. 181/106

(57) ABSTRACT

Acoustic measurements made in a borehole using a multipole source are used for imaging a near-borehole geological formation structure and determination of its orientation. The signal to noise ratio (as defined by the ratio of the signal radiated into the formation to the axially propagating signal) depends upon the type of source (force or volume) and its position in the borehole (on the tool, in the fluid or on the borehole wall).

### CROSS-REFERENCES TO RELATED APPLICATIONS

This application claims priority from U.S. Provisional Patent Application Ser. No. 61/029,806 filed on 19 Feb. 2008.

### BACKGROUND OF THE DISCLOSURE

1. Field of the Disclosure

This disclosure relates generally to systems for drilling and logging boreholes for the production of hydrocarbons and more particularly to a drilling system having an acoustic measurement-while-drilling (“MWD”) system as part of a bottomhole assembly, or an after-drilling wireline logging system having an acoustic device for measuring acoustic velocities of subsurface formations, during or after drilling of the wellbores and determining the location of formation bed boundaries around the bottomhole assembly, as in the MWD system, or around the wireline logging system. Specifically, this disclosure relates to the imaging of bed boundaries using directional acoustic sources. For the purposes of this disclosure, the term “bed boundary” is used to denote a geologic bed boundary, interface between layers having an acoustic impedance contrast, or a subsurface reflection point. For the purposes of this disclosure, the term acoustic is intended to include, where appropriate, both compressional and shear properties.

2. Description of the Related Art

To obtain hydrocarbons such as oil and gas, boreholes (wellbores) are drilled through hydrocarbon-bearing subsurface formations. A large number of the current drilling activity involves drilling “horizontal” boreholes. Advances in the MWD measurements and drill bit steering systems placed in the drill string enable drilling of the horizontal boreholes with enhanced efficiency and greater success. Recently, horizontal boreholes, extending several thousand meters (“extended reach” boreholes), have been drilled to access hydrocarbon reserves at reservoir flanks and to develop satellite fields from existing offshore platforms. Even more recently, attempts have been made to drill boreholes corresponding to three-dimensional borehole profiles. Such borehole profiles often include several builds and turns along the drill path. Such three dimensional borehole profiles allow hydrocarbon recovery from multiple formations and allow optimal placement of wellbores in geologically intricate formations.

Hydrocarbon recovery can be maximized by drilling the horizontal and complex wellbores along optimal locations within the hydrocarbon-producing formations (payzones). Important to the success of these wellbores is to: (1) establish reliable stratigraphic position control while landing the wellbore into the target formation, and (2) properly navigate the drill bit through the formation during drilling. In order to achieve such wellbore profiles, it is important to determine the true location of the drill bit relative to the formation bed boundaries and boundaries between the various fluids, such as the oil, gas and water. Lack of such information can lead to severe “dogleg” paths along the borehole resulting from hole or drill path corrections to find or to reenter the payzones. Such wellbore profiles usually limit the horizontal reach and the final wellbore length exposed to the reservoir. Optimization of the borehole location within the formation can also have a substantial impact on maximizing production rates and minimizing gas and water coning problems. Steering efficiency and geological positioning are considered in the industry among the greatest limitations of the current drilling systems for drilling horizontal and complex wellbores. Availability of relatively precise three-dimensional subsurface seismic maps, location of the drilling assembly relative to the bed boundaries of the formation around the drilling assembly can greatly enhance the chances of drilling boreholes for maximum recovery. Prior art methods lack in providing such information during drilling of the boreholes.

Modem directional drilling systems usually employ a drill string having a drill bit at the bottom that is rotated by a drill motor (commonly referred to as the “mud motor”). A plurality of sensors and MWD devices are placed in close proximity to the drill bit to measure certain drilling, borehole and formation evaluation parameters. Such parameters are then utilized to navigate the drill bit along a desired drill path. Typically, sensors for measuring downhole temperature and pressure, azimuth and inclination measuring devices and a formation resistivity measuring device are employed to determine the drill string and borehole-related parameters. The resistivity measurements are used to determine the presence of hydrocarbons against water around and/or a short distance in front of the drill bit. Resistivity measurements are most commonly utilized to navigate or “geosteer” the drill bit. However, the depth of investigation of the resistivity devices usually extends to 2-3 m. Resistivity measurements do not provide bed boundary information relative to the downhole subassembly. Furthermore, the error margin of the depth-measuring devices, usually deployed on the surface, is frequently greater than the depth of investigation of the resistivity devices. Thus, it is desirable to have a downhole system which can relatively accurately map the bed boundaries around the downhole subassembly so that the drill string may be steered to obtain optimal borehole trajectories.

Thus, the relative position uncertainty of the wellbore being drilled and the important near-wellbore bed boundary or contact is defined by the accuracy of the MWD directional survey tools and the formation dip uncertainty. MWD tools are deployed to measure the earth's gravity and magnetic field to determine the inclination and azimuth. Knowledge of the course and position of the wellbore depends entirely on these two angles. Under normal operating conditions, the inclination measurement accuracy is approximately ±0.2°. Such an error translates into a target location uncertainty of about 3.0 m. per 1000 m. along the borehole. Additionally, dip rate variations of several degrees are common. The optimal placement of the borehole is thus very difficult to obtain based on the currently available MWD measurements, particularly in thin pay zones, dipping formation and complex wellbore designs.

One of the earliest teachings of the use of borehole sonic data for imaging of near-borehole structure is that of Hornby, who showed that the full waveforms recorded by an array of receivers in a modern borehole sonic tool contain secondary arrivals that are reflected from near-borehole structural features. These arrivals were used to form an image of the near-borehole structural features in a manner similar to seismic migration. Images were shown with distances of up to 18 m. from the borehole. Hornby, like most prior art approaches for imaging while drilling, used monopole seismic sources.

U.S. Pat. No. 6,084,826 to Leggett, having the same assignee as the present application and the contents of which are fully incorporated herein by reference, discloses a downhole apparatus comprising a plurality of segmented transmitters and receivers which allows the transmitted acoustic energy to be directionally focused at an angle ranging from essentially 0″ to essentially 180″ with respect to the axis of the borehole. Downhole computational means and methods are used to process the full acoustic wave forms recorded by a plurality of receivers. The ability to control both the azimuth and the bearing of the transmitted acoustic signals enables the device to produce images in any selected direction.

A problem with the prior art methods is that with the exception of Hornby, examples of images are not presented and it is difficult to estimate the resolution of the images and the distances that can be adequately imaged. Furthermore, Hornby does not address the problem of determining the azimuth of formation boundaries.

A problem with prior art methods is the relatively poor signal-to-noise ratio. The problem is related to guided modes in general. For a monopole (i.e., a multipole excitation employing sources with equal polarity) excitation, this guided wave is the Stoneley wave. For a dipole excitation this is the tool flexural mode, for a quadrupole excitation this is the quadrupole mode and for a hexapole excitation this is the hexapole mode. If in any of these excitations source imbalances occur or the tool is eccentered a weighted mix of all other guided modes will be added. Of these so called mode contaminants, the Stoneley wave has the highest amplitude. As a result of this, signals received in a borehole are dominated by the Stoneley wave making it very difficult to detect reflections from bed boundaries.

U.S. Pat. No. 7,035,165 to Tang having the same assignee as the present disclosure and the contents of which are incorporated herein by reference discloses a method in which a plurality of multicomponent acoustic measurements are obtained at a plurality of depths and for a plurality of source-receiver spacings on the logging tool. An orientation sensor on the logging tool, preferably a magnetometer, is used for obtaining an orientation measurement indicative of an orientation of the logging tool. The multicomponent measurements are rotated to a fixed coordinate system (such as an earth based system defined with respect to magnetic or geographic north) using the orientation measurement, giving rotated multicomponent measurements. The rotated multicomponent measurements are processed for providing an image of the subsurface. While the problem of Stoneley waves is not specifically discussed in Tang, examples shown by Tang and good signal-to-noise ratio for imaging of bed boundaries. The present disclosure deals with further improvements in MWD acoustic imaging.

### SUMMARY OF THE DISCLOSURE

One embodiment of the disclosure is a method of imaging an interface in an earth formation. The method includes deploying an acoustic tool in a borehole, activating a transmitter on the acoustic tool near a wall of the borehole to generate a first wave in the earth formation, and producing a signal in at least one receiver on the acoustic tool responsive to a reflection of the first wave by the interface and responsive to a direct arrival through the borehole responsive to the activation of the transmitter. A mode of the reflection of the first wave is selected to have an arrival time at the at least one receiver that is later than an arrival time of the direct arrival.

Another embodiment of the disclosure is a system configured to image an interface in an earth formation. The system includes an acoustic tool configured to be conveyed into a borehole, a transmitter on the acoustic tool near a wall of the borehole configured to generate a first wave in the earth formation, and at least one receiver on the acoustic tool configured to provide a signal responsive to a reflection of the first wave by the interface and responsive to a direct arrival through the borehole responsive to the activation of the transmitter. The produced signal further comprises a mode of the reflection of the first wave that has an arrival time at the at least one receiver later than an arrival time of a direct arrival through the borehole responsive to the activation of the transmitter.

Another embodiment of the disclosure is a computer-readable medium accessible to a processor. The medium includes instructions which enable the processor to produce an image of an interface in an earth formation using a signal produced by at least one receiver on an acoustic tool conveyed in a borehole responsive to activation of a transmitter on the acoustic tool positioned near a wall of the borehole, the signal including a direct arrival through the borehole responsive to activation of the transmitter and a reflection of an acoustic wave from the interface resulting from a wave generated into the formation by the transmitter, wherein an arrival time of the reflection is later than an arrival time of the direct arrival.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1A shows a schematic diagram of a drilling system that employs the apparatus of the current disclosure in a logging-while-drilling (LWD) embodiment;

FIG. 1B illustrates a LWD tool on a drill collar;

FIG. 2 shows the geometry of a logging tool in a borehole with a dipping bed boundary crossing the borehole;

FIG. 3 (prior art) illustrates velocity dispersion curves for formation and drill-collar dipole modes;

FIG. 4 (prior art) illustrates velocity dispersion curves for formation and drill-collar quadrupole modes;

FIG. 5 illustrates a quadrupole transmitter suitable for the method of the present disclosure;

FIG. 6 illustrates a typical borehole acoustic imaging configuration showing an acoustic array logging tool;

FIG. 7 is a perspective view of the geometry of FIG. 6;

FIG. 8 is a representation of a multipole source of order n in a borehole;

FIG. 9 shows monopole (Stoneley) excitation functions and phase slowness for different positions of a volume source;

FIG. 10 shows dipole excitation functions and phase slowness for different positions of a volume source,

FIG. 11 shows quadrupole excitation functions and phase slowness for different positions of a volume source;

FIG. 12 shows hexapole excitation functions and phase slowness for different positions of a volume source,

FIG. 13 shows monopole (Stoneley) excitation functions and phase slowness for different positions of a force source;

FIG. 14 shows dipole excitation functions and phase slowness for different positions of a force source,

FIG. 15 shows quadrupole excitation functions and phase slowness for different positions of a force source;

FIG. 16 shows hexapole excitation functions and phase slowness for different positions of a force source, and

FIG. 17 shows the results of quadrupole force source simulation at different distances from the tool.

### DESCRIPTION OF AN EMBODIMENT

The present disclosure deals with a method, system and apparatus for imaging of bed boundaries in an earth formation. To the extent that the following description is specific to a particular embodiment or a particular use of the disclosure, this is intended to be illustrative and is not to be construed as limiting the scope of the disclosure. The embodiment of the disclosure is described with reference to a measurement-while-drilling configuration. This is not to be construed as a limitation, and the method of the present disclosure can also be carried out in wireline logging.

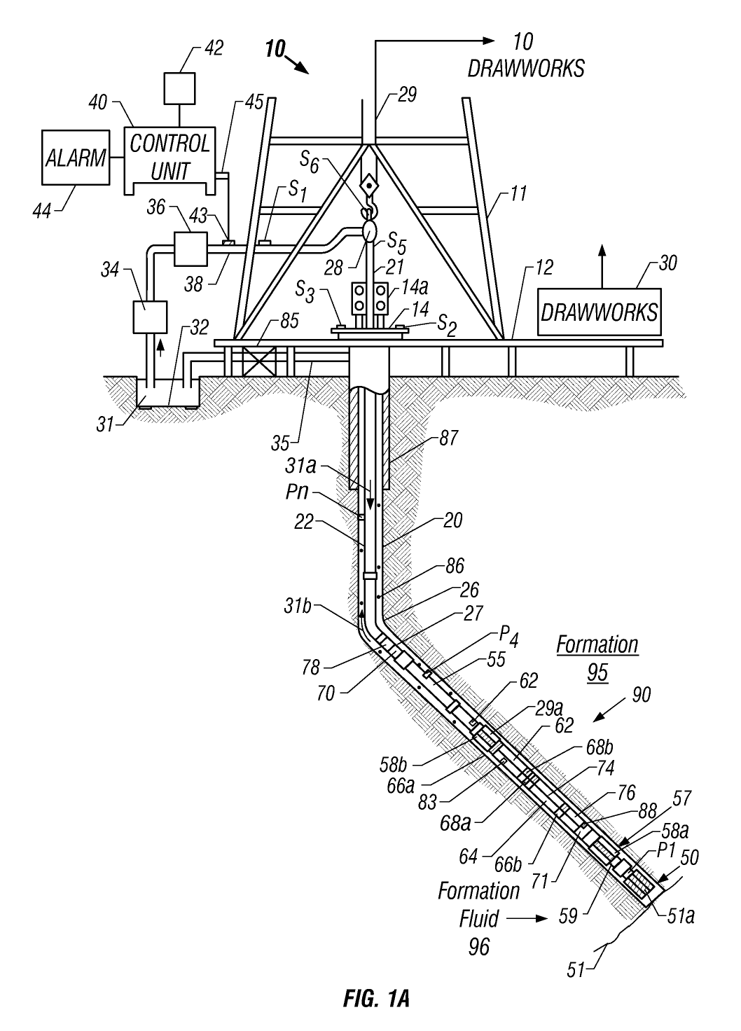

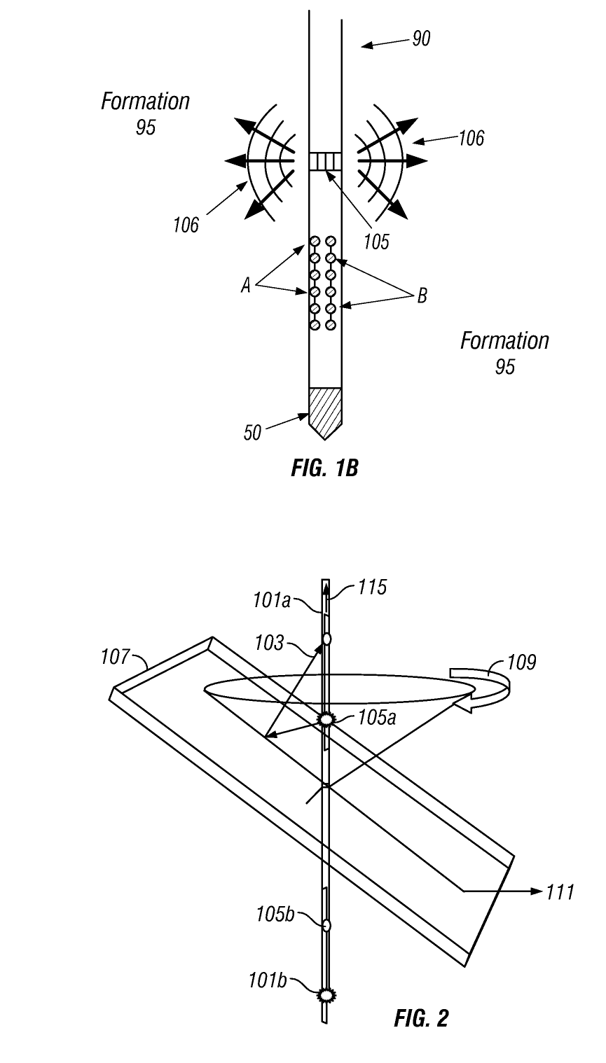

FIG. 1A shows a schematic diagram of a drilling system 10 having a bottom hole assembly (BHA) or drilling assembly 90 that includes sensors for downhole wellbore condition and location measurements. The BHA 90 is conveyed in a borehole 26. The drilling system 10 includes a conventional derrick 11 erected on a floor 12 which supports a rotary table 14 that is rotated by a prime mover such as an electric motor (not shown) at a desired rotational speed. The drill string 20 includes a tubing (drill pipe or coiled-tubing) 22 extending downward from the surface into the borehole 26. A drill bit 50, attached to the drill string 20 end, disintegrates the geological formations when it is rotated to drill the borehole 26. The drill string 20 is coupled to a drawworks 30 via a kelly joint 21, swivel 28 and line 29 through a pulley (not shown). Drawworks 30 is operated to control the weight on bit (“WOB”), which is an important parameter that affects the rate of penetration (“ROP”). A tubing injector 14a and a reel (not shown) are used instead of the rotary table 14 to inject the BHA into the wellbore when a coiled-tubing is used as the conveying member 22. The operations of the drawworks 30 and the tubing injector 14a are known in the art and are thus not described in detail herein.

During drilling, a suitable drilling fluid 31 from a mud pit (source) 32 is circulated under pressure through the drill string 20 by a mud pump 34. The drilling fluid passes from the mud pump 34 into the drill string 20 via a desurger 36 and the fluid line 38. The drilling fluid 31 discharges at the borehole bottom 51 through openings in the drill bit 50. The drilling fluid 31 circulates uphole through the annular space 27 between the drill string 20 and the borehole 26 and returns to the mud pit 32 via a return line 35 and drill-cutting screen 85 that removes the drill cuttings 86 from the returning drilling fluid 31b. A sensor S1 in line 38 provides information about the fluid flow rate. A surface torque sensor S2 and a sensor S3 associated with the drill string 20 respectively provide information about the torque and the rotational speed of the drill string 20. Tubing injection speed is determined from the sensor Ss, while the sensor S6 provides the hook load of the drill string 20.

In some applications only rotating the drill pipe 22 rotates the drill bit 50. However, in many other applications, a downhole motor 55 (mud motor) is disposed in the drilling assembly 90 to rotate the drill bit 50 and the drill pipe 22 is rotated usually to supplement the rotational power, if required, and to effect changes in the drilling direction. In either case, the ROP for a given BHA largely depends on the WOB or the thrust force on the drill bit 50 and its rotational speed.

The mud motor 55 is coupled to the drill bit 50 via a drive disposed in a bearing assembly 57. The mud motor 55 rotates the drill bit 50 when the drilling fluid 31 passes through the mud motor 55 under pressure. The bearing assembly 57 supports the radial and axial forces of the drill bit 50, the downthrust of the mud motor 55 and the reactive upward loading from the applied weight on bit. A lower stabilizer 58a coupled to the bearing assembly 57 acts as a centralizer for the lowermost portion of the drill string 20.

A surface control unit or processor 40 receives signals from the downhole sensors and devices via a sensor 43 placed in the fluid line 38 and signals from sensors S1-S6 and other sensors used in the system 10 and processes such signals according to programmed instructions provided to the surface control unit 40. The surface control unit 40 displays desired drilling parameters and other information on a display/monitor 42 that is utilized by an operator to control the drilling operations. The surface control unit 40 contains a computer, memory for storing data, recorder for recording data and other peripherals. The surface control unit 40 also includes a simulation model and processes data according to programmed instructions. The control unit 40 is preferably adapted to activate alarms 44 when certain unsafe or undesirable operating conditions occur.

The BHA may also contain formation evaluation sensors or devices for determining resistivity, density and porosity of the formations surrounding the BHA. A gamma ray device for measuring the gamma ray intensity and other nuclear and non-nuclear devices used as measurement-while-drilling devices are suitably included in the BHA 90. As an example, FIG. 1A shows an example resistivity-measuring device 64 in BHA 90. It provides signals from which resistivity of the formation near or in front of the drill bit 50 is determined. The resistivity device 64 has transmitting antennae 66a and 66b spaced from the receiving antennae 68a and 68b. In operation, the transmitted electromagnetic waves are perturbed as they propagate through the formation surrounding the resistivity device 64. The receiving antennae 68a and 68b detect the perturbed waves. Formation resistivity is derived from the phase and amplitude of the detected signals. The detected signals are processed by a downhole computer 70 to determine the resistivity and dielectric values.

An inclinometer 74 and a gamma ray device 76 are suitably placed along the resistivity-measuring device 64 for respectively determining the inclination of the portion of the drill string near the drill bit 50 and the formation gamma ray intensity. Any suitable inclinometer and gamma ray device, however, may be utilized for the purposes of this disclosure. In addition, position sensors, such as accelerometers, magnetometers or gyroscopic devices may be disposed in the BHA to determine the drill string azimuth, true coordinates and direction in the wellbore 26. Such devices are known in the art and are not described in detail herein.

In the above-described configuration, the mud motor 55 transfers power to the drill bit 50 via one or more hollow shafts that run through the resistivity-measuring device 64. The hollow shaft enables the drilling fluid to pass from the mud motor 55 to the drill bit 50. In an alternate embodiment of the drill string 20, the mud motor 55 may be coupled below resistivity measuring device 64 or at any other suitable place. The above described resistivity device, gamma ray device and the inclinometer are preferably placed in a common housing that may be coupled to the motor. The devices for measuring formation porosity, permeability and density (collectively designated by numeral 78) are preferably placed above the mud motor 55. Such devices are known in the art and are thus not described in any detail.

As noted earlier, a significant portion of the current drilling systems, especially for drilling highly deviated and horizontal wellbores, utilize coiled-tubing for conveying the drilling assembly downhole. In such application a thruster 71 is deployed in the drill string 90 to provide the required force on the drill bit. For the purpose of this disclosure, the term weight on bit is used to denote the force on the bit applied to the drill bit during the drilling operation, whether applied by adjusting the weight of the drill string or by thrusters. Also, when coiled-tubing is utilized a rotary table does not rotate the tubing; instead it is injected into the wellbore by a suitable injector 14a while the downhole motor 55 rotates the drill bit 50. The BHA also includes, in a suitable position, an acoustic tool described further below.

FIG. 1B is a schematic view of an acoustic logging while drilling tool system on a BHA drill collar 90 containing a drill bit 50. This system is mounted on the BHA drill collar 90 for performing acoustic measurements while the formation is being drilled. The acoustic logging while drilling tool system has a source 105 to emit acoustic vibrations 106 that may traverse formation 95 and may also be propagated along the borehole wall and be received by sensors A and B which may be in arrays. These sensors are discussed later in the application. A point to note is that the sensors are disposed between the transmitter and the receiver. This has important benefits in that the desired signal produced by the transmitter travels in a direction opposite to the direction of noise generated by the drillbit 50. This makes it possible to use suitable filtering techniques, including phased arrays, to greatly reduce the drillbit noise. In an alternate embodiment of the disclosure, the transmitter 105 may be located between the sensors and the drillbit 50.

FIG. 2 illustrates how borehole acoustic measurement can obtain the geological structural information away from the borehole. Depicted is a logging tool having one or more sources 101a, 101b crossing a dipping bed 107 intersecting the borehole 115. As an acoustic source on the tool is energized, it generates acoustic waves that can be classified into two categories according their propagation direction. The first is the waves that travel directly along the borehole. These direct waves are received by an array of receivers (not shown) on the tool and subsequently used to obtain acoustic parameters, such as velocity, attenuation, and anisotropy, etc., for the formation adjacent to the borehole. The waves of the second category are the acoustic energy that radiates away from the borehole and reflects back to the borehole from boundaries of geological structures. These waves are called secondary arrivals in acoustic logging data because their amplitudes are generally small compared to those of the direct waves. As shown in this figure, depending on whether the tool is below or above the bed, acoustic energy strikes the lower or upper side of the bed and reflects back to the receiver as the secondary arrivals. An exemplary raypath 103 for such a reflected wave is shown. These secondary arrivals can be migrated to image the formation structural feature away from the borehole, in a way similar to the surface seismic processing. For the purposes of the present disclosure, the information of interest is contained in these reflected waves and the direct waves propagating through the borehole and the drill collar are noise.

To date, much near-borehole acoustic imaging has been preformed using measurements made by monopole acoustic tools. Monopole compressional waves with a center frequency around 10 kHz are commonly used for the imaging. The acoustic source of a monopole tool has an omni-directional radiation pattern and the receivers of the tool record wave energy from all directions. Consequently, acoustic imaging using monopole tools is unable to determine the strike azimuth 111 of the near-borehole structure. This uncertainty is depicted as 109 in FIG. 2. This is easily understood from FIG. 2, where the acoustic reflection originates from a line on the bed that intersects the borehole along the bed's strike direction. Without the ability to resolve the azimuth of the acoustic reflection, the reflection line and its strike azimuth cannot be determined because any bed plane tangential with a cone around the borehole axis can contribute to the acoustic image.

Tang '165 discusses in detail how in combination of dipole and monopole measurements can be used to resolve this ambiguity. This uses the fact that dipole measurements are directional in nature.

The application of the dipole acoustic technology to LWD has a drawback caused by the presence of the drilling collar with BHA that occupies a large part of the borehole. The drawback is that the formation dipole shear wave traveling along the borehole is severely contaminated by the dipole wave traveling in the collar. This is demonstrated by the theoretical analysis/numerical modeling results discussed in U.S. Pat. No. 6,850,168 to Tang et al, having the same assignee as the present application and the contents of which are incorporated herein by reference.

The dipole wave excitation and propagation characteristics for a borehole with a drilling collar are analyzed. Using known analyses methods, for example the analyses of the type described in Schmitt (1988), one can calculate the velocity dispersion curve for the formation and collar dipole shear (flexural) waves. The dispersion curve describes the velocity variation of a wave mode with frequency. In the example, the borehole diameter is 23.84 cm and the inner- and outer diameter of the collar is 5.4 and 18 cm. respectively. The inner collar column and the annulus column between the collar and borehole are filled with drilling mud whose acoustic velocity and density are 1,470 ds and 1 g/cc, respectively. The collar is made of steel (compressional velocity, shear velocity and density of steel are 5,860 m/s, 3,130 m/s, and 7.85 g/cc, respectively). The formation is acoustically slow with compressional velocity of 2,300 m/s, shear velocity 1,000 m/s, and density 2 g/cc. It is to be noted that the example is for illustrative purposes only and not intended to be a limitation on the scope of the disclosure.

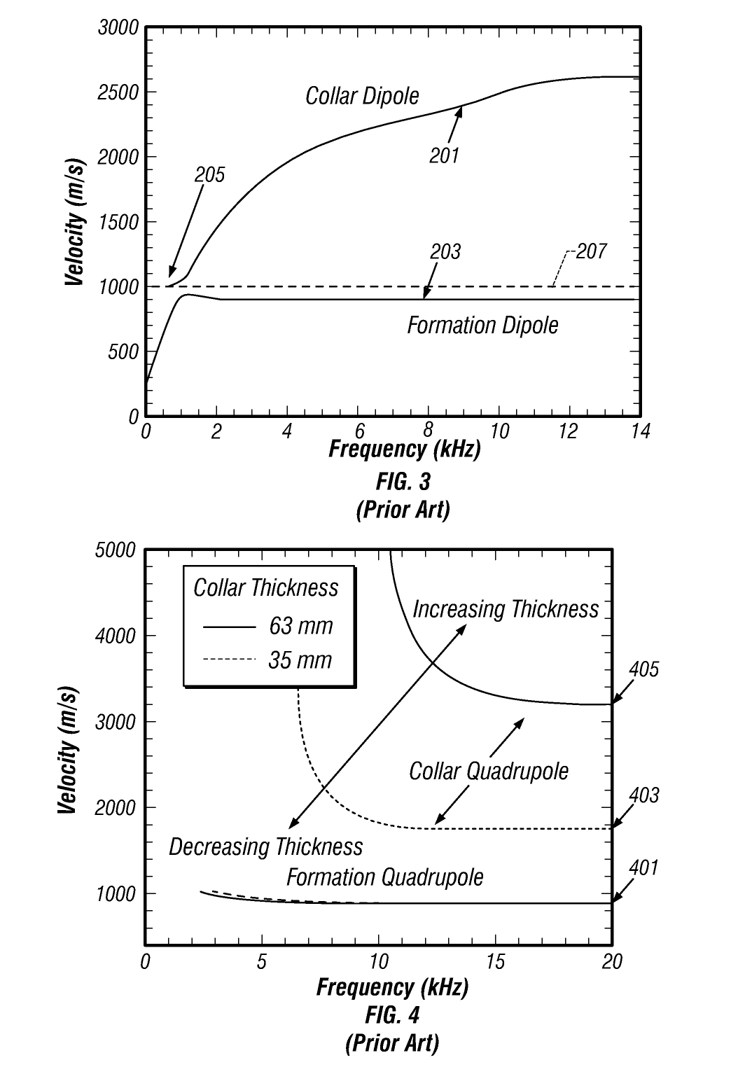

The calculated drilling collar and formation flexural wave dispersion curves for dipole modes are shown in FIG. 3, for the frequency range shown as the horizontal axis of 0 to 14 kHz. The collar dipole wave dispersion curve 201 displayed along the vertical axis shows how velocity of the collar dipole wave varies with frequency over the range 0 to 14 kHz. The formation dipole wave dispersion curve 203 shows that except for low frequencies in this range, there is relatively little change in velocity. The formation and collar flexural wave modes coexist almost for the entire frequency range, except at the very low frequency where the collar flexural mode appears to terminate at the formation shear velocity. Below the frequency where the collar mode terminates, the formation of flexural mode velocity appears to continue the collar flexural mode behavior that would exist in the absence of the formation, the velocity decreasing to zero at the zero frequency. This cross-over phenomenon is caused by the strong acoustic interaction between the collar and the formation in this dipole excitation situation. The dipole collar wave as well as any Stoneley wave generated by the source will degrade the image quality.

The feasibility of formation imaging from quadrupole wave measurement is demonstrated using theoretical/numerical analysis examples. FIG. 4 shows the velocity dispersion curves of the formation 401 and collar quadrupole waves 403 and 405. Velocity in meter per second (m/s) is displayed along the vertical axis and frequency in kilohertz (kHz) along the horizontal axis. The velocity dispersion curve for an exemplary collar of thickness 35 mm is shown as curve 403. The velocity dispersion curve for an exemplary collar of thickness 63 mm is shown as curve 405. The formation quadrupole wave is slightly dispersive and reaches the formation shear wave velocity at a low cut-off frequency (around 2 kHz in this case). This indicates that formation shear wave velocity can be determined as the low frequency limit of the velocity of formation quadrupole waves. The collar quadrupole wave velocity curve shows very high values due to the high shear rigidity (steel) and thick wall (63 mm) of the drilling collar. The collar wave for the 63 mm thick collar 405, however, exists only in the frequency range above 10 kHz; whereas, the required frequency for shear velocity measurement of the formation is around 2 kHz, well separated from the frequency range (>10 kHz) of the collar wave. This frequency separation allows for designing a method and apparatus to generate quadrupole waves only in a predetermined frequency band (0-10 kHz in this case). In this band, only the formation quadrupole wave is generated. This wave excitation/generation scheme may be demonstrated using finite difference simulations.

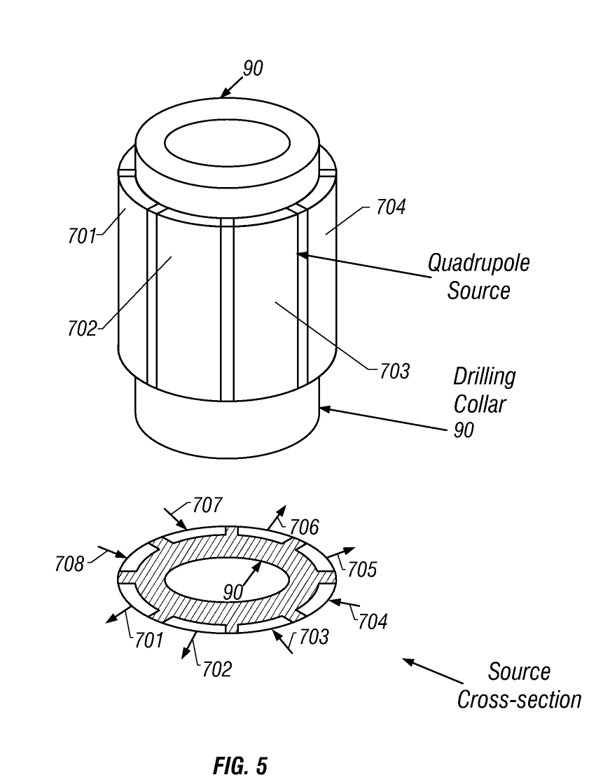

Thus, by using a quadrupole excitation at low frequency, noises propagating along the borehole are considerably reduced. As shown in FIG. 5, the quadrupole source comprises the drilling collar 90 and eight members of equal dimension. The sections are number 701-708. These members are eight equal sectors of the source cylinder. The cylinder sections are made from either an electrostrictive (or piezoelectric) or a magnetostrictive material capable of generating stress/pressure wave signals from the input electric pulse. In an alternate embodiment of the disclosure (not shown) the sections comprise electromechanical devices. By use of suitably configured portholes, dipole or quadrupole pulses may be produced. Bender bars may also be used. Although dividing the source cylinder into four equal sectors suffices to produce a quadrupole source, using eight (or any multiple of four) sectors for the source reduces the mass of each sector so they more easily withstand drilling vibrations. While the description of the source herein uses eight source segments as an example, those versed in the art would recognize how any multiple of four sources could be excited to produce a quadrupole signal.

The lower part of FIG. 5 is a cross-sectional view of the quadrupole shear wave source on the plane perpendicular to the axis of the drilling collar. The elements of the source device are, in one embodiment, eight sectors labeled 701, 702, 703, 704, 705, 706, 707 and 708. When electrical pulses are applied to the source, each sector will expand or contract in a radially outward or inward manner. Specifically, the electrical pulses can be applied such that sectors (701, 702) and diametrically opposed sectors (705, 706) will expand and simultaneously, sectors (703, 704) and sectors (707, 708) will contract, as illustrated in FIG. 5. Then four stress/pressure waves will be generated in the surrounding borehole fluid/formation, as well as in the drilling collar. It is also to be noted that there may only be a single actuator that produces quadrupole signals from suitable portholes.

When all eight sectors are made from the same material and the electrical pulses applied to them have substantially the same amplitude, then the interaction of the four pressure/stress waves inside the drilling collar and in the surrounding borehole/formation will produce quadrupole shear waves. More specifically, if the electrical pulses are modulated such that the frequency band of the generated pressure/stress waves is below the cut-off frequency of the quadrupole shear wave in the drilling collar, then the interaction of the four stress waves in the collar will cancel each other. The interaction of the pressure/stress wave in the borehole and formation will produce a formation quadrupole shear wave to propagate longitudinally along the borehole. This frequency band modulation of the source pulses is part of one embodiment of the present disclosure.

The reflected signal may be received by a quadrupole receiver having a structure similar to that of the quadrupole transmitter. In a typical configuration, the outputs of the elements of the quadrupole receiver are input to a preamplifier. An analog to digital converter converts the amplified signal into digital data that may then be stored and are processed.

In a typical LWD environment the selected wavefield is contaminated by two sources: Drilling/pump noise, and borehole guided modes that propagate up and down the BHA due to BHA outer diameter (OD) variations along the axial direction of the BHA (e.g., tool joints, stabilizers, etc.). A low frequency quadrupole excitation yields a low amplitude (borehole guided) quadrupole mode, but no Stoneley wave if sources are amplitude/phase matched and the tool is centered. The lower the quadrupole excitation frequency, the lower the quadrupole mode Stoneley wave amplitude. As opposed to the monopole scenario, in this scenario, at the receiver array, a (potentially) scattered formation compressional/shear body wave will have to compete with a BHA scattered borehole quadrupole wave.

Since outward propagating formation compressional/shear body waves have similar amplitudes in both monopole and quadrupole excitation, it can be seen that formation compressional/shear scattered wave image is can better be obtained from a quadrupole excitation than from a monopole excitation. The lower the frequency, the more favorable the quadrupole excitation will be over the monopole excitation. In one embodiment of the disclosure, a frequency of less than 1 kHz is used. Low frequency (<2 kHz) multipole excitations have the additional advantage that the initial requirement of imaging away from the wellbore at distances up to 50 m, is more likely to be met. A far-field analysis of P and S-waves due to a multipole excitation of order n shows that, the higher the excitation order, the lower their amplitude. Although the far-field amplitude decay as a function of distance away from the source is the same for P and S-waves, irrespective of excitation order, their ‘absolute’ amplitudes are scaled by a factor

$${( \frac{R}{λ} )}^{m}$$

, where R is the multipole source radius, λ is the P or S-wave wavelength and m is the modal number, i.e., m=0 is monopole, m=1 is dipole, etc. Other than this, the advantages of a quadrupole or hexapole excitation over a monopole or dipole excitation still hold.

Tang '165 resolves the azimuth ambiguity noted above using a combination of monopole and dipole acoustic measurements. A similar method can be used to resolve the azimuth ambiguity using a combination of monopole and quadrupole acoustic measurements.

The discussion above addressed one source of possible noise for MWD measurements, namely guided waves and how they effect determination of formation velocities. Different considerations apply for imaging applications. Generally, in a typical acoustic array tool configuration, borehole guided waves (e.g., Stoneley, dipole, quadrupole and hexapole mode) arrive at times equal to or greater than the formation shear arrival time. Particulary when compressional (P) waves are used for imaging, these borehole guided modes will overshadow near wellbore P-P reflections. In an LWD environment this effect is amplified due to the small annular space between tool and borehole, which significantly increases the amplitude of borehole guided modes in comparison to a corresponding wireline configuration.

Due to the desired depth of investigation and spatial resolution we are forced to operate at a center frequency of approximately 0.5-2 kHz. It is important to acquire data on an almost continuous basis (>1 sample/2 ft) during the drilling process. Because the drilling/flow noise frequency range is overlapping with the frequency range of interest, it is clear that especially formation scattered waves (reflections) might be adversely affected by it. We next discuss factors to be considered in designing a system for imaging away from a borehole.

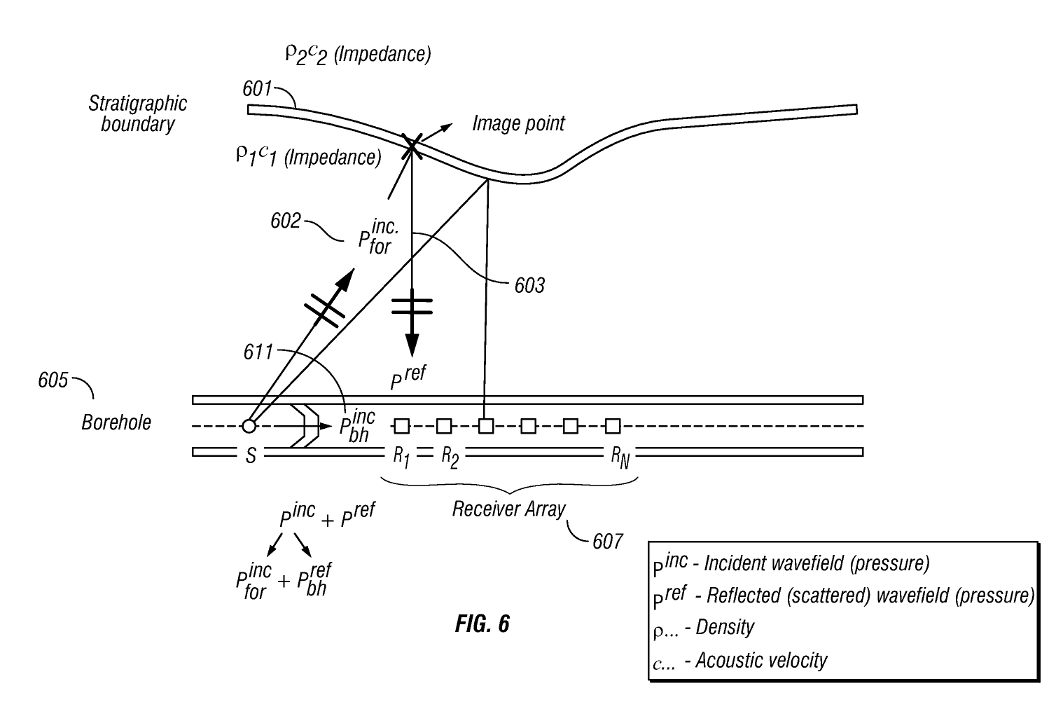

Referring now to FIG. 6, shown is an acoustic array logging tool 607 in a borehole 605. A wave denoted by P_{for}^{inc} is generated in the formation by the source. This results in two reflected waves from the interface, one corresponding to a reflected shear wave mode and the other corresponding to a reflected compressional wave mode. One of these is illustrated in FIG. 6 by P^{ref}. To simplify the illustration, the other reflected wave mode is not shown. The earliest arrival 603 P^{ref} from a reflection at the interface 601 should arrive at the receiver array later than the latest 611 direct arrival P_{bh}^{inc} through the borehole in the array. This favors P-S and S-S reflections over P-P reflections, i.e., regardless of the type of wave generated by the source into the formation, a shear reflection is more likely to satisfy the requirement that the reflected arrival be later than the direct arrival.

Since, under all practical circumstances it is possible that P^{ref} will interfere with P_{bh}^{inc}, and because of drilling/flow noise it makes sense to consider borehole excitation types and locations that maximize P_{for}^{inc}, the incident wave in the formation 602, and therefore P^{ref}, while reducing P_{bh}^{inc}. This favors borehole wall contact sources over anything else. For the purposes of the present disclosure, we adopt the following definition:

1: at, within, or to a short distance or time

Merriam-Webster Online. 23 Jan. 2009

and use the terminology “near a wall of the borehole” to include a source that is in contact with the borehole wall.

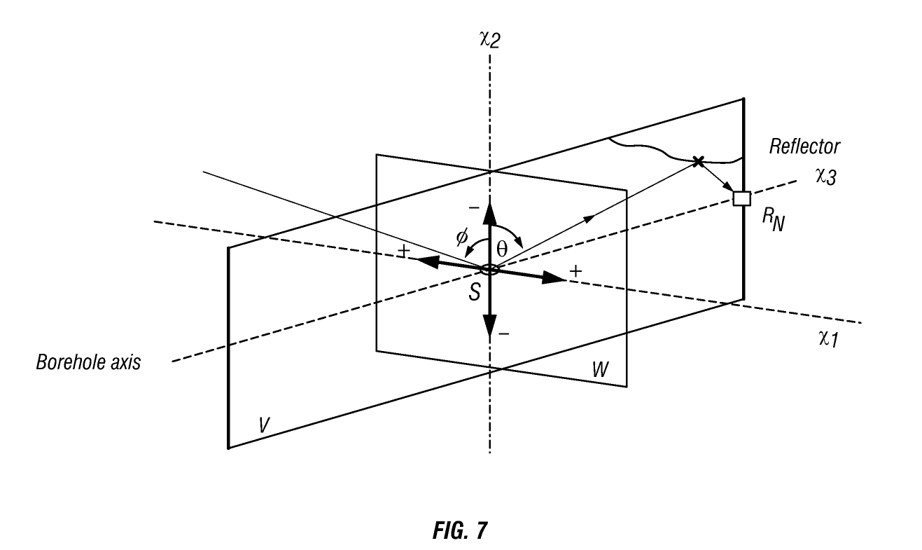

With reference to FIG. 7, the source directivity pattern in the x₂-x₃ plane (Θ direction, where x₁ is along the borehole axis) should be as omni-directional as possible. The plane, V, coinciding with the x₂-x₃ plane is spanned by two unit vectors; one has the direction of the incident ray and one has the direction of the source-receiver line (i.e., the borehole/tool axis). A quadrupole force source excitation is indicated using black arrows.

The source frequency content should be in the 0.5-2 kHz range. This is to ensure the desired depth of investigation (15-30 m) and spatial resolution (3-10 m). It may or may not be possible to satisfy all the criteria simultaneously. There are a variety of different solutions that place different relative emphasis on the criteria above.

In this disclosure we disclose a variety of multipole borehole wall contact sources, each of which has certain advantages and disadvantages. In what follows, a concise summary of the different embodiments is given.

In elasto-dynamics two fundamental (ideal) source types can be distinguished. The first is the volume injection source. A point volume injection source represents an omni-directional discontinuity in particle velocity (i.e., a local vacuum is created). The second is the force source. A point force source represents a (directional) discontinuity in stress. Finite size ‘real’ sources can be considered point sources at observation distances large compared to the characteristic dimension of that source and effectively behave like either a volume injection source, a force source or a combination thereof. Although experiments are needed to confirm this, the latter two behaviors appear to be more realistic.

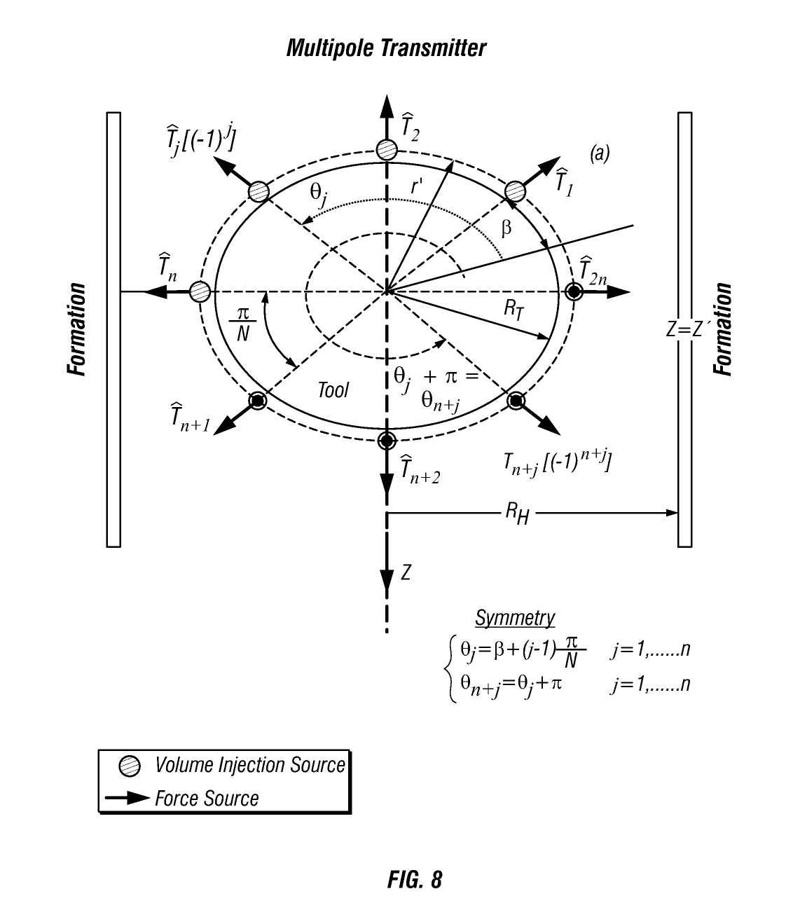

We next generalize the concept of a quadrupole source (shown in FIG. 5) to a multipole source of order n, shown in FIG. 8. The most general form of a multipole source of order n is a collection of 2n point sources (Volume injection or force type) placed on a circle of radius r′ and separated by π/n radians. Relative to the established literature this is an extended definition, in the following ways:
1. Where the literature speaks of sources having ‘alternating’ polarity, the current definition allows for any polarity distribution.
2. Where the literature only speaks of volume injection sources, the current definition also allows for force sources.
   In this context, we now discuss the following excitation regimes:
A. n=1, 2, 3, . . . , N Nε [symbol] , sources having equal polarity, sources being of the volume injection type, force type, or a combination thereof and deployed at the borehole wall. [symbol] is the set of real numbers. These excitation types approximate the perfect monopole. The approximation becomes perfect as n→∞.
B. n=1, 2, 3, . . . , N Nε [symbol] , sources having alternating polarity, sources being of The volume injection type, force type, or a combination thereof and deployed at the borehole wall. These excitation types are referred to as dipole, quadrupole, hexapole, . . . , etc., respectively.

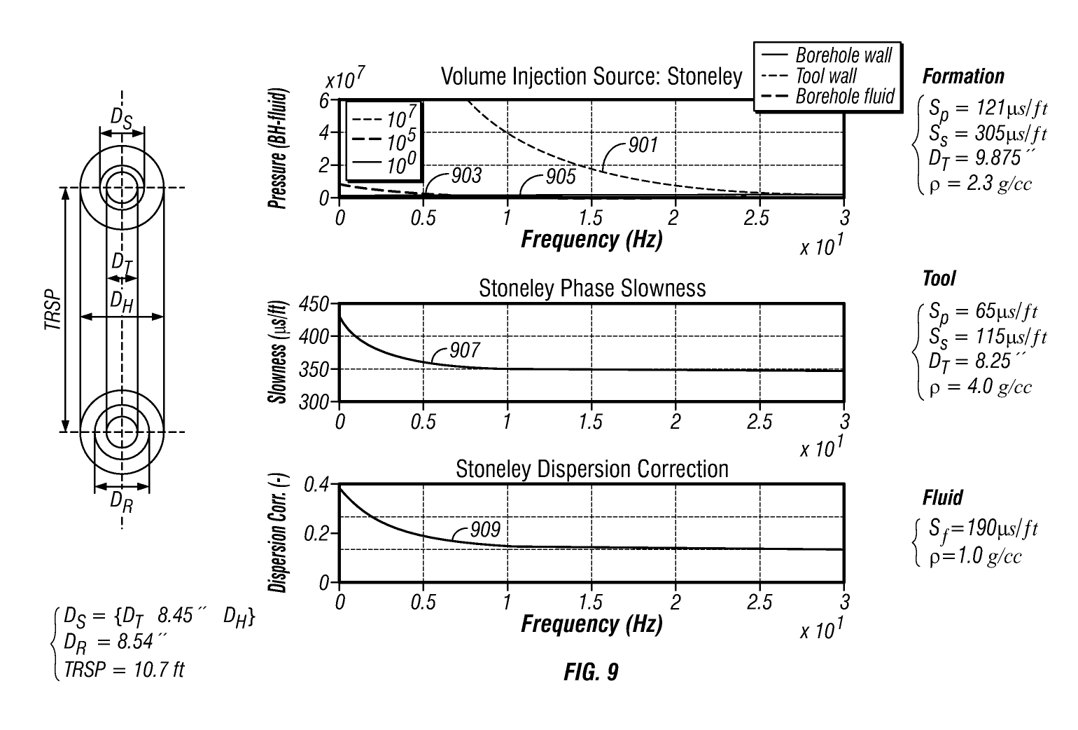

In FIG. 9, we show monopole Stoneley mode excitation functions as a result of a volume injection multipole source excitation of order n, deployed at the different positions: DS=DT (Source deployed at Tool wall) 901, DS=8.45″ (Source deployed in borehole fluid) 903 and DS=DH (Source deployed at boreHole wall) 905. The excitation functions were calculated at an axial offset (TRSP) of 10.7 ft and a radial offset equal to DR 2. The simulation results are indicative of the amplitude of the direct arrival discussed above with reference to FIG. 6. It is clearly desirable to have this signal be as low as possible so that the arrival time of reflected signal may be more easily determined. Note that the relative scales of the curves 901, 903 and 905 are 10⁷, 10⁵ and 10⁰ respectively. The top panel shows the excitation functions, the middle panel shows the phase slowness 907 (which is independent of source position), and the bottom panel shows the fractional difference 909 between the phase slowness and the formation shear slowness. The elastic properties and density of the formation, tool and borehole fluid are indicated to the right of the figure. Borehole and tool diameter are indicated as well. A clear advantage of this excitation type is the strong reduction in Stoneley wave amplitude (7 orders of magnitude) when changing from a tool wall deployed to a borehole wall deployed multipole source. This, combined with an anticipated increase in formation scattered wave amplitudes (P^{ref}. in FIG. 6), makes these excitation regimes potential candidates for an imaging tool. The only unfavorable aspect of Stoneley waves is their relatively late arrival time when excited at low frequencies (<2 kHz) as is indicated by the bottom panel of FIG. 9. In this frequency range the Stoneley wave is 20-40% slower than the formation shear wave.

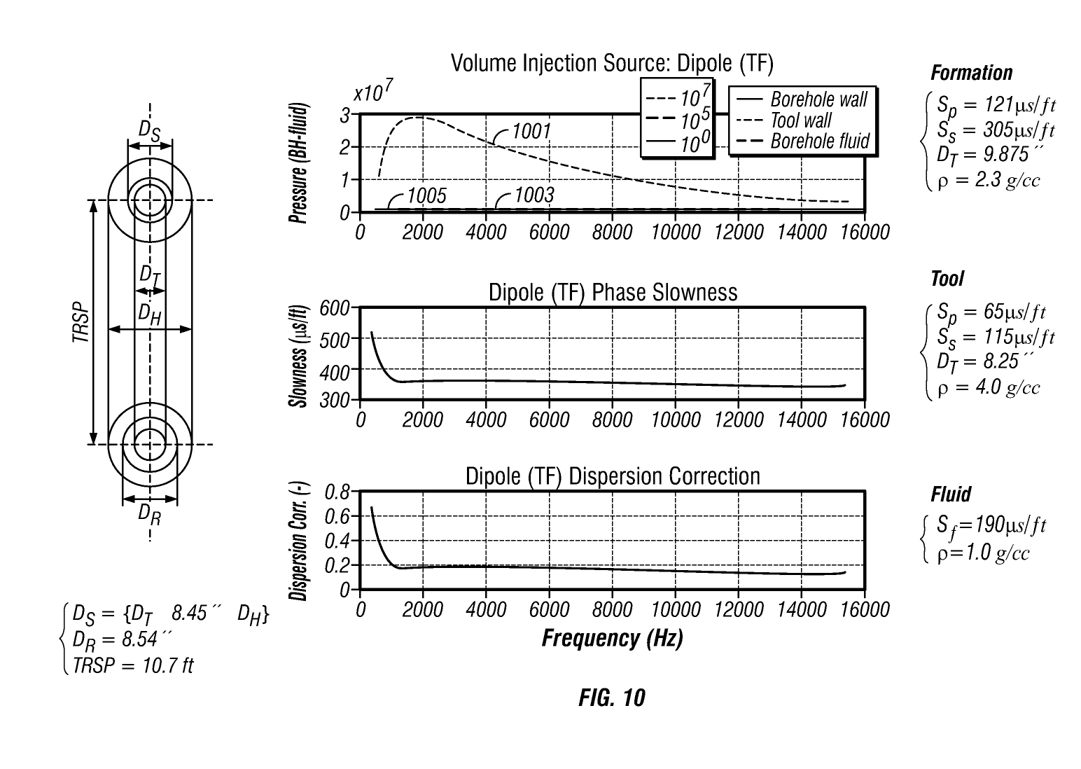

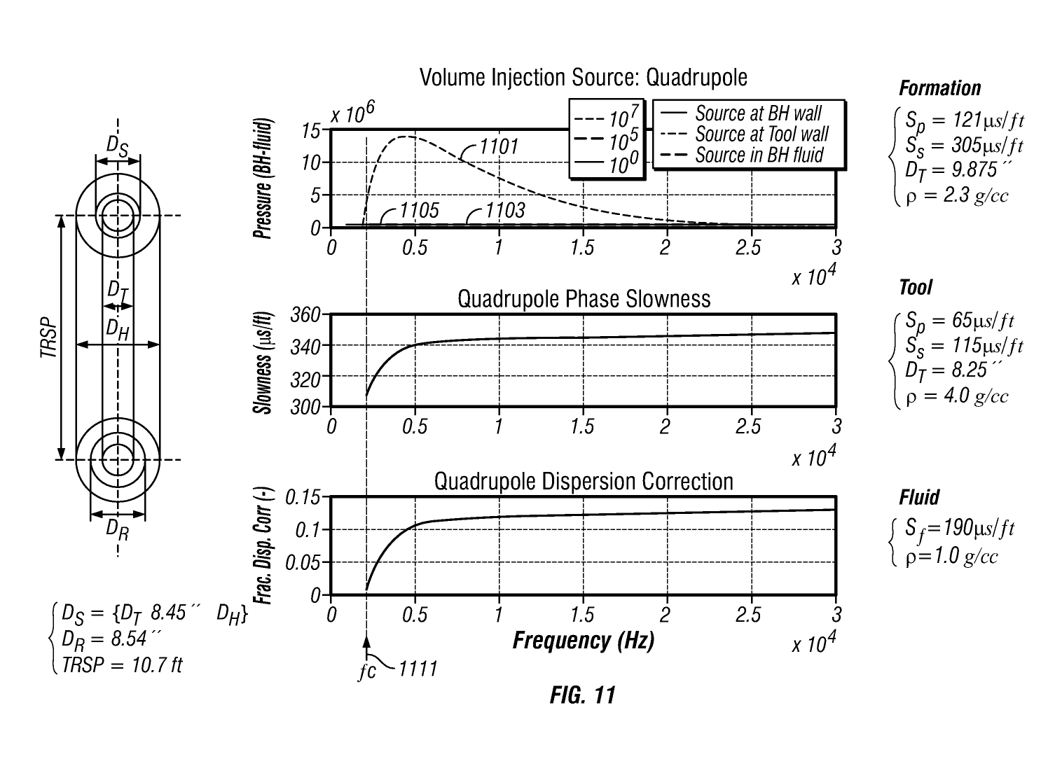

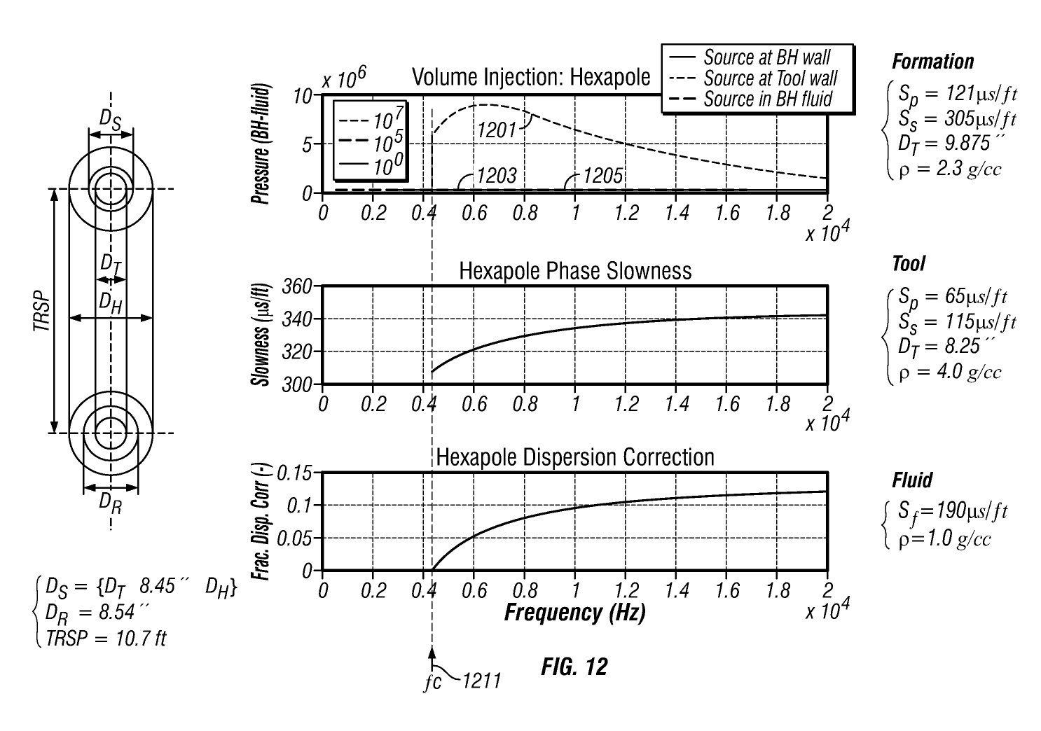

Amplitude-wise, very similar results are obtained for dipole (n=1), quadrupole (n=2) and hexapole (n=3) as is indicated in FIG. 10, FIG. 11 and FIG. 12, respectively. In FIG. 10, curves 1001, 1003, 1005 pertain to a (multipole) dipole source deployed at the tool wall, in the fluid and the borehole wall respectively. In FIG. 11, curves 1101, 1103, 1105 pertain to a (multipole) quadrupole source deployed at the tool wall, in the fluid and the borehole wall respectively. In FIG. 12, curves 1201, 1203, 1205 pertain to a (multipole) hexapole source deployed at the tool wall, in the fluid and the borehole wall respectively.

Similar to the monopole Stoneley wave, the dipole wave (i.e., tool flexural wave) has the disadvantage that at low frequencies (<2 kHz) its slowness dramatically increases, i.e., from 20% above shear (@2 kHz) to 60% above shear (@0.5 kHz). Quadrupole and hexapole show slightly different results. These modes are characterized by a so called cutoff frequency, f_{c}, as indicated by 1111 in FIG. 11 and by 1211 in FIG. 12, respectively. At frequencies ≦f_{c}, these modes propagate with true formation shear slowness, independent of source position, and their amplitudes become equally small (i.e., of the same order) as frequency decreases below f_{c}. This occurs because at these (relatively) low frequencies the radial wavelength is much greater than the borehole (and tool) radius and consequently tool and borehole no longer affect these modes. At frequencies above f_{c}, the interplay between the wave's radial wavelength and the tool/borehole diameter becomes very noticeable, reaching a (amplitude) maximum at a resonance frequency (Approximately 4 kHz for quadrupole and 6 kHz for hexapole). However, also in this frequency range (>f_{c}), we observe, similar to the monopole and dipole case, a 7 orders in magnitude amplitude drop going from a tool-wall source location to a formation-wall deployed source.

Clearly, from a slowness perspective, at frequencies below f_{c} the borehole wall deployed quadrupole and hexapole (volume injection) excitation appear to be even better excitation candidates for an imaging tool than monopole or dipole. Furthermore, relative to quadrupole, hexapole has the advantage that the cutoff point, f_{c}, occurs at a higher frequency (4 kHz versus 2 kHz, respectively).

As to the judgment of whether a borehole-wall deployed volume injection quadrupole or hexapole excitation deserves preference over a borehole wall deployed volume injection monopole or dipole excitation, a word of caution is warranted. As noted above, a so called far field analysis of P and S-waves due to a multipole excitation (volume injection or force source) of order n shows that, the higher the excitation order, the lower their amplitude. Although the far-field amplitude decay as a function of distance away from the source is the same for P and S-waves, irrespective of excitation order, their ‘absolute’ amplitudes are scaled by a factor

$${( \frac{R}{λ} )}^{m}$$

where R is the multipole source radius, λ is the P or S-wave wavelength and m is the modal number, i.e., m=0 is monopole, m=1 is dipole, etc. Other than this, the advantages of a quadrupole or hexapole excitation over a monopole or dipole excitation still hold.

As for a physical explanation for the excessive amplitude decay that occurs when changing from a tool wall or borehole fluid deployed multipole volume injection source to a borehole wall deployed one, the following is noted. The amplitude of borehole guided modes (e.g., Stoneley, dipole, quadrupole, hexapole, etc.) propagating along the borehole axis is to the first order determined by borehole wall shear particle motion (i.e., particle motion perpendicular to the borehole axis). Whenever a multipole volume injection source is deployed at the tool wall or in the borehole fluid, there is a strong incident wavefield directly impinging on the borehole wall and giving rise to relatively strong borehole wall shear particle motion. This is NOT true when the multipole volume injection source is deployed at the borehole wall. A borehole wall deployed volume injection source will not excite any direct shear particle motion in the surrounding formation or the adjacent borehole fluid. The incident wavefield first has to reflect from the tool body prior to impinge upon the surrounding borehole wall, thereby exciting particle shear motion.

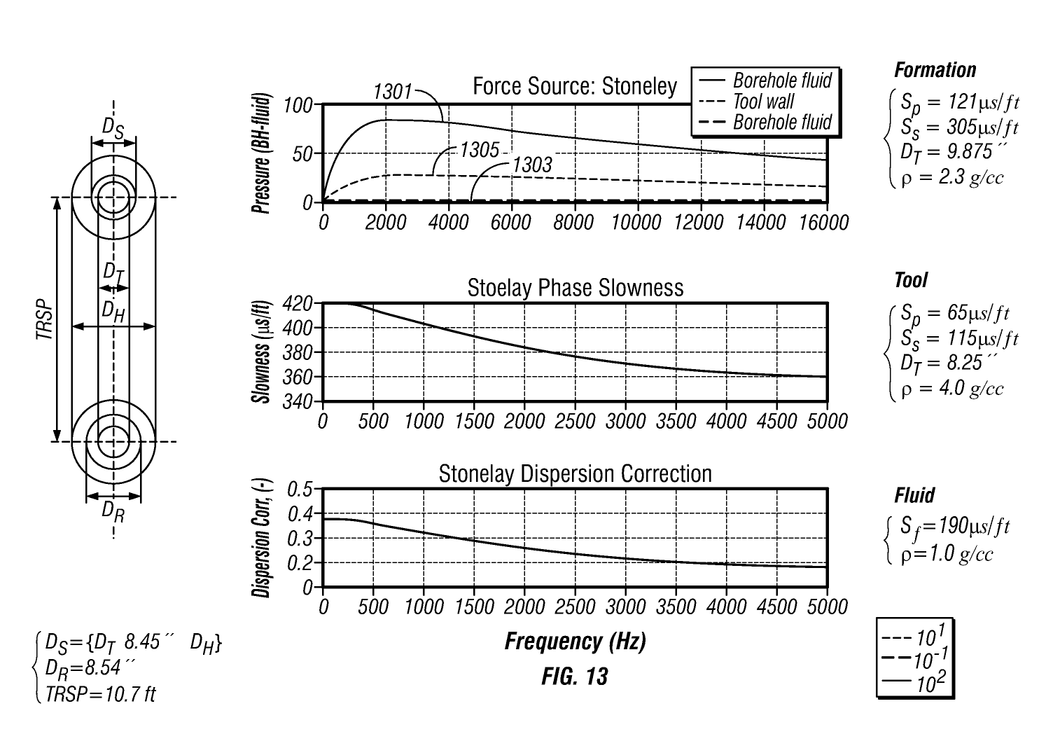

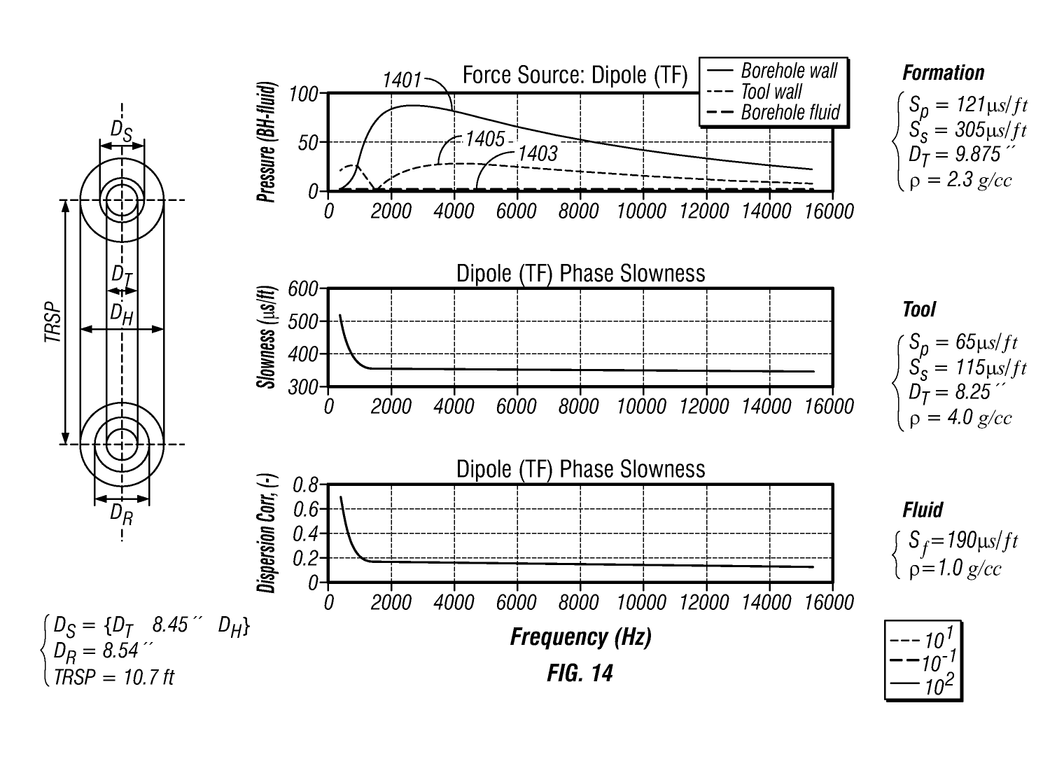

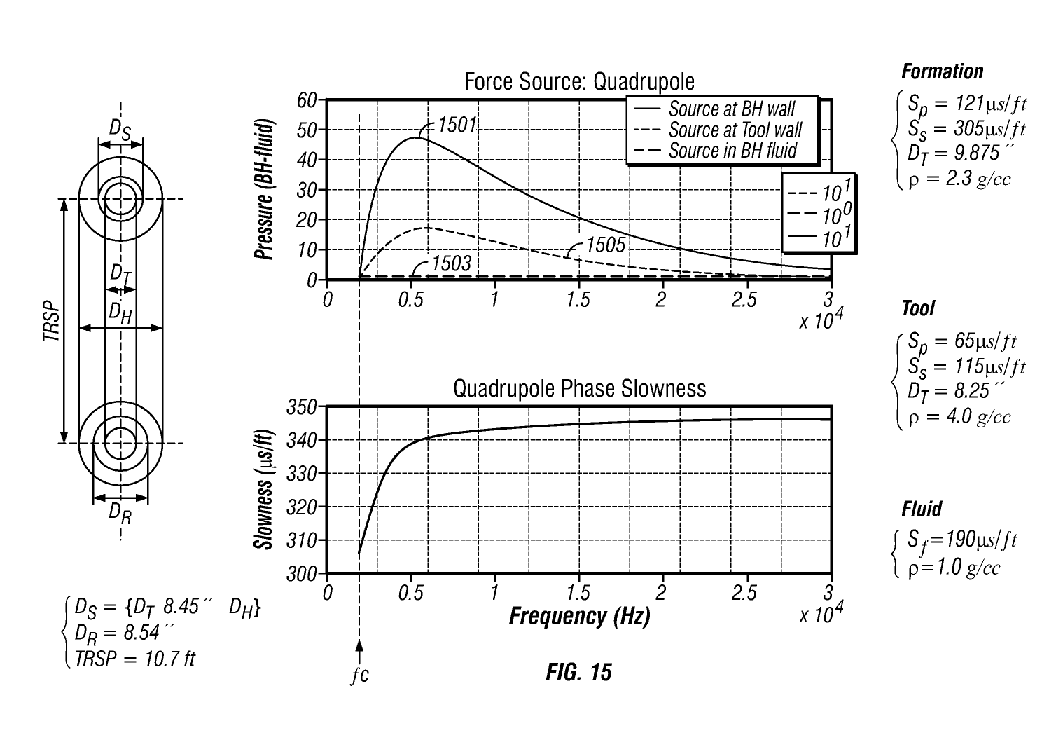

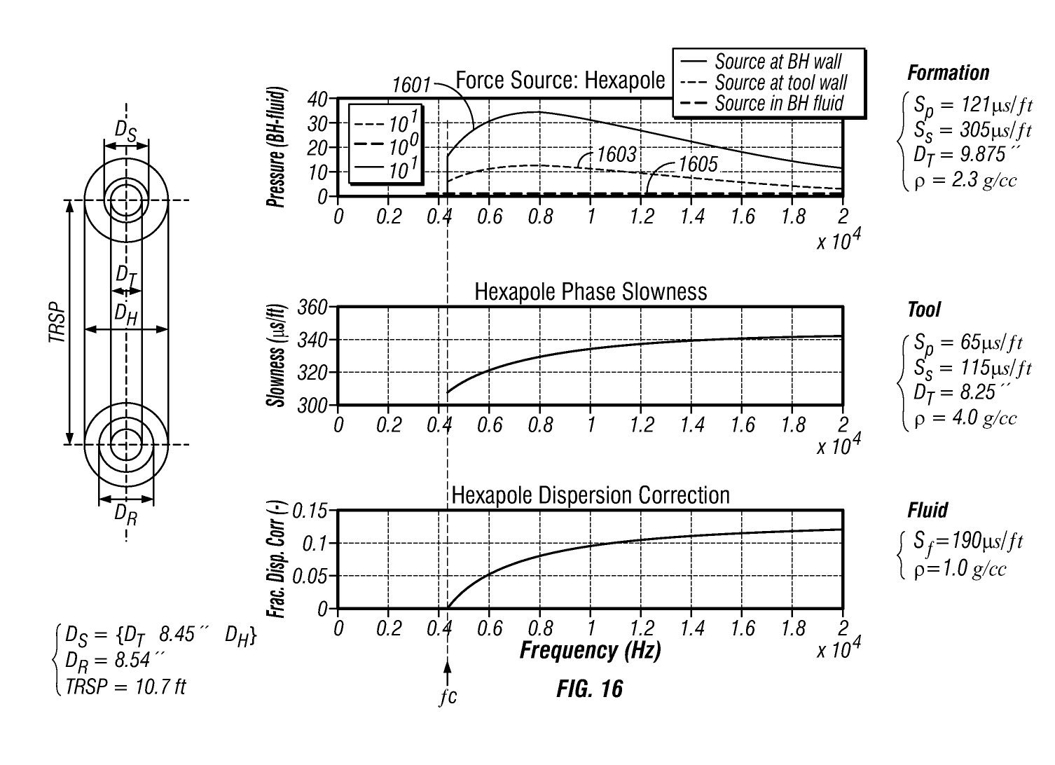

The above reasoning is supported by FIG. 13, FIG. 14, FIG. 15 and FIG. 16 which show the modeling results for the monopole (Stoneley mode), dipole (Tool flexural mode), quadrupole and hexapole mode, respectively, employing a corresponding multipole force source excitation. In obtaining these results the same modeling parameters were used as in the corresponding volume injection cases. Not surprisingly, highest amplitudes are obtained when the multipole force source is deployed at the borehole wall (1301, 1401, 1501, 1601) where it excites very strong borehole wall shear particle motion. The lowest amplitudes are obtained when the source is deployed in the borehole fluid (1303, 1403, 1503, 1603). Furthermore, the amplitude variations due to a varying source position, is far less dramatic than in the volume injection case. It is only 2 to 3 orders of magnitude, as opposed to 7 orders of magnitude in the corresponding volume injection cases. In general (i.e., not taking the variations with frequency into account) it appears that by changing from a tool wall (1305, 1405, 1505, 1605) to a borehole wall multipole force source excitation, the borehole mode amplitudes are increased roughly by factor of 2-4. Preferably, this should be compensated for by an even greater increase of the borehole scattered wave amplitudes (P^{ref}. in FIG. 6).

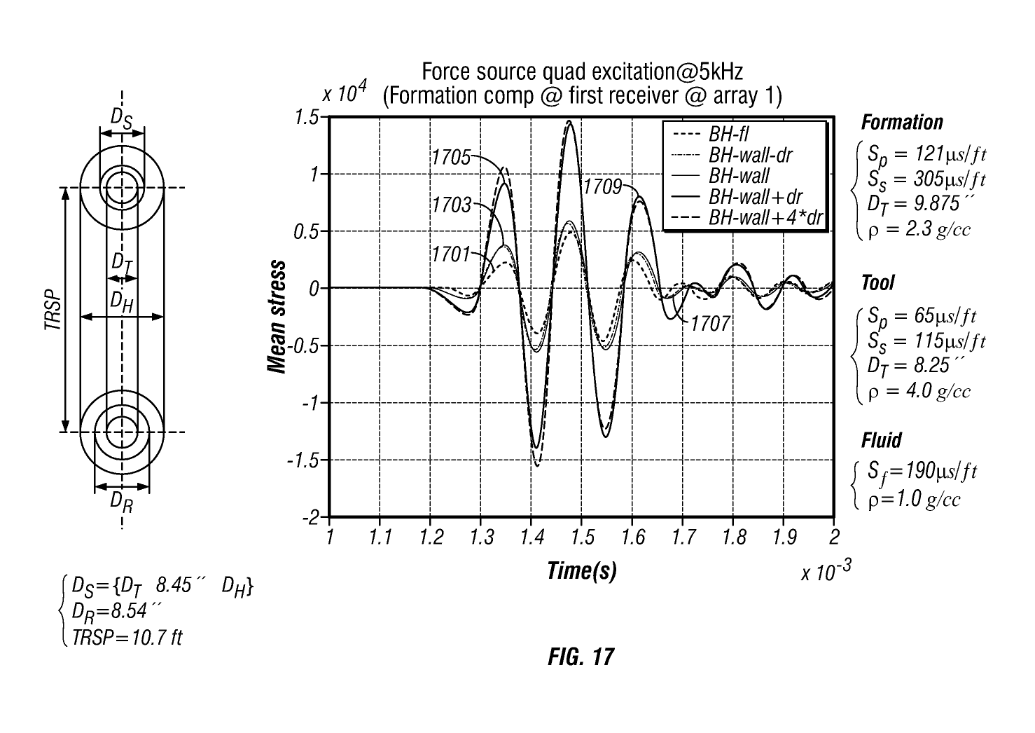

FIG. 17 shows simulation results for a 5 kHz quadrupole force source excitation. The curve 1701 is with the source in a borehole fluid. The curve 1703 is for the source on the borehole wall. The curves 1705, 1707, 1709 were generated to see if any artifacts might result from averaging of the material properties at the fluid/formation interface, this being a problem which commonly occurs in Finite difference time domain (FDTD) modeling. 1705 is for the source +2 mm from the wall, 1707 is for the source −2 mm from the wall, and 1709 is for the source 8 mm from the wall, 2 mm being the radial grid size used in the FDTD.

Shown are the first receiver compressional waves in the formation for an array which has zero axial offset and 9.47 ft. (2.89 m) radially offset from the source. Little difference is noted between the signal strength with the source in the fluid (1701), at the borehole wall (1703) and −2 mm from the borehole wall (1707). The curves 1705, 1709 which correspond to the source positively displaced into the formation show larger signals, which is to be expected. The maximum obtainable amplitude increase in outward propagating formation P-waves does between 1701 and 1703 certainly not exceed a factor of 3. Note however, that just as in the volume injection case, a word of caution is warranted. Far field P- and S-waves amplitudes are scaled by a factor

$${( \frac{R}{λ} )}^{m}$$

where R is the multipole source radius, λ is the P or S-wave wavelength and m is the modal number, i.e., m=0 is monopole, m=1 is dipole, etc.

The processing of the data may be done by a processor to give imaged measurements substantially in real time. The imaging may be carried out using the method disclosed in Tang. It should be noted that the disclosure in Tang includes the acquisition of cross-dipole data. The present disclosure may be implemented without this additional acquisition, so that the additional steps in Tang specific to cross-dipole data do not have to be implemented. The processing may be done by a downhole processor. Implicit in the control and processing of the data is the use of a computer program on a suitable machine readable medium that enables the processor to perform the control and processing. The machine readable medium may include ROMs, EPROMs, EEPROMs, Flash Memories and Optical disks.

The foregoing description is directed to particular embodiments of the present disclosure for the purpose of illustration and explanation. It will be apparent, however, to one skilled in the art that many modifications and changes to the embodiment set forth above are possible without departing from the scope and the spirit of the disclosure. It is intended that the following claims be interpreted to embrace all such modifications and changes.

What is claimed is:

1. A method of imaging an interface in an earth formation, the method comprising:
deploying an acoustic tool in a borehole;
activating a transmitter on the acoustic tool near a wall of the borehole to generate a first wave in the earth formation; and
producing a signal in at least one receiver on the acoustic tool responsive to a reflection of the first wave by the interface and responsive to a direct arrival through the borehole responsive to the activation of the transmitter;
wherein producing the signal further comprises selecting a mode of the reflection of the first wave that has an arrival time at the at least one receiver later than an arrival time of the direct arrival.

2. The method of claim 1 wherein selecting the mode of the reflection further comprises selecting a shear wave mode.

3. The method of claim 1 wherein the first wave further comprises a shear wave.

4. The method of claim 1 further comprising using, for the transmitter, a source selected from: (i) a volume injection source, and (ii) a force source.

5. The method of claim 1 further comprising using, for the transmitter, a plurality of sources of alternating polarity.

6. The method of claim 5 wherein the plurality of alternating sources define one of: (i) a quadrupole, and (ii) a hexapole.

7. The method of claim 1 further comprising using the signal to provide an image of the interface.

8. The method of claim 1 further comprising controlling a direction of drilling using the image.

9. A system configured to image an interface in an earth formation, the system comprising:
an acoustic tool configured to be conveyed into a borehole;
a transmitter on the acoustic tool and near a wall of the borehole configured to generate a first wave in the earth formation; and
at least one receiver on the acoustic tool configured to provide a signal responsive to a reflection of the first wave by the interface and responsive to a direct arrival through the borehole responsive to the activation of the transmitter;
wherein the produced signal further comprises a mode of the reflection of the first wave that has an arrival time at the at least one receiver later than an arrival time of a direct arrival through the borehole responsive to the activation of the transmitter.

10. The system of claim 9 wherein the mode of the reflection further comprises a shear wave mode.

11. The system of claim 9 wherein the first wave that the transmitter is configured to generate further comprises a shear wave.

12. The system of claim 9 wherein the transmitter further comprises a source selected from: (i) a volume injection source, and (ii) a force source.

13. The system of claim 9 wherein the transmitter further comprises a plurality of sources of alternating polarity.

14. The system of claim 13 wherein the plurality of alternating sources define one of: (i) a quadrupole, and (ii) a hexapole.

15. The system of claim 9 further comprising at least one processor configured to use the signal to provide an image of the interface.

16. The system of claim 15 wherein the at least one processor is further configured to control a direction of drilling using the image.

17. A computer-readable medium accessible to a processor, the medium comprising instructions which enable the processor to:
produce an image of an interface in an earth formation using a signal produced by at least one receiver on an acoustic tool conveyed in a borehole responsive to activation of a transmitter on the acoustic tool positioned near a wall of the borehole, the signal including a direct arrival through the borehole responsive to activation of the transmitter and a reflection of an acoustic wave from the interface resulting from a wave generated into the formation by the transmitter, wherein an arrival time of the reflection is later than an arrival time of the direct arrival.

18. The computer-readable medium of claim 17 further comprising at least one of: (i) a ROM, (ii) an EPROM, (iii) an EEPROM, (iv) a flash memory, and (v) an optical disk.
